(19) United States
(12) Patent Application Publication
(10) Pub. No.: US 2012/0072336 A1
(43) Pub. Date: Mar. 22, 2012

(54) METHOD AND APPARATUS FOR GLOBAL UNDERWRITING AND EXPRESS LOAN ORIGINATION

(75) Inventors: Heather M. Le Vine, Harrisburg, NC (US); Heather B. Antonio, Jacksonville, FL (US); Patricia L. Moore, Salisbury, NC (US); Sarah L. Torres, Apopka, FL (US); Josh D. Collins, Gastonia, NC (US); Gulden Yazgen, Bay Point, CA (US); Anthony D. Zuress, Charlotte, NC (US); William J. Burgess, Jacksonville, FL (US); Renita Destefano, Harrisburg, NC (US)

(73) Assignee: Bank of America, Charlotte, NC (US)

(21) Appl. No.: 13/182,487

(22) Filed: Jul. 14, 2011

Related U.S. Application Data
(60) Provisional application No. 61/383,638, filed on Sep. 16, 2010.

(51) Int. Cl. G06Q 40/00

(52) U.S. Cl. 705/38

(57) ABSTRACT

A method and apparatus that allow a rapid evaluation and origination of loans is provided. The creditworthiness of potential borrowers may be evaluated by multiple models. Some models may provide a nuanced evaluation of creditworthiness, while other models generate cross-sell opportunities. The models may implement a strategy. The model may be run on a logic engine or engines. The evaluation may utilize multiple stages, whereby each stage is reached only if the earlier stages are passed. Evaluation may utilize a multi-level strategy. In the event that a loan cannot be reasonably provided, the potential borrower may be given suitable reasons and/or be presented with alternative credit products.

### CROSS-REFERENCE TO RELATED APPLICATION

This application is a non-provisional application of U.S. Provisional Patent Application No. 61/383,638 filed on Sep. 16, 2010, entitled, “Customer Scoring.”

### FIELD OF TECHNOLOGY

Aspects of the disclosure relate to computing global underwriting scores for the purpose of rapid loan origination.

### BACKGROUND

Loan origination requires an assessment of the creditworthiness of a borrower. The evaluation of creditworthiness is often a cumbersome process involving multiple persons and ad-hoc rules. A potential borrowing opportunity for a loan may be lost during the evaluation process. However, rapid extension of credit may lead to losses in the absence of appropriate due diligence.

It would be desirable, therefore, to provide apparatus and methods that allow a loan officer to rapidly evaluate the creditworthiness of a potential borrower. Likewise it would be desirable to provide a consistent and thorough process for evaluation of creditworthiness.

### SUMMARY

An Express Loan Origination (ELO) method and apparatus is provided. The ELO may be a portion of a Global Underwriting Solution (GUS). The ELO may utilize a set of rules to evaluate the creditworthiness of a potential loan customer. Different sets of rules will be applied depending on the various criteria—e.g. the size of the loan, the type of collateral.

In the event that a loan is approved or even when a loan is not approved, other products, often called cross-sell opportunities, may be offered to the potential borrower. The cross-sell opportunity may include products such as checking accounts, debit cards or any other suitable product.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of an exemplary circuit board for use with a self-service device according to the invention;

FIG. 2 shows a flow diagram for the method of Express Loan Origination;

FIG. 3A shows a flow diagram for a first portion of a method of Express Loan Origination;

FIG. 3B shows a flow diagram for a second portion of a method of Express Loan Origination;

FIG. 4A shows a flow diagram for a first portion of a method of Express Loan Origination utilizing a rules engine; and

FIG. 4B shows a flow diagram for a second portion of a method of Express Loan Origination utilizing a rules engine.

### DETAILED DESCRIPTION OF THE DISCLOSURE

An Express Loan Origination (ELO) method and apparatus is provided. The ELO system may utilize various rules, stages and levels to ascertain the creditworthiness of a potential borrower. If the borrower is creditworthy then a second operation may complete the loan process. A potential borrower may be a small business, a large enterprise, a single person or any other suitable borrower.

More specifically, a small business express loan origination module according to the invention may be used with together with a GUS application. Preferably, the module may utilize minimum fields required. Further, an application according to the invention may run through a series of known and/or proprietary strategies to generate and/or obtain a fail condition subject to an override capability. In such a circumstance, systems and methods according to the invention may automatically send adverse action letters. Certain embodiments of the invention may display results of the known and/or proprietary strategies.

In some embodiments of the invention, credit bureau integration with a Small Business Financial Exchange, Consumer and Business bureaus may also be implemented, as will be described in more detail below.

Following successful completion of the ELO, the application may then be ported into the existing origination module of GUS.

The loans types offered may be unsecured loans, secured loans, card based products—credit cards, debit cards etc.—or any other suitable loan type.

As described above, the ELO system may be a portion of a global underwriting solution. The user of the ELO system is preferably an officer at a bank but the ELO may also be operated by other bank employees or the potential borrower.

The ELO system may also generate offers of alternate credit arrangements or related products in response to further evaluation of the potential borrower. These offers may be part of a cross-sell system within the ELO. The offers may be made whether or not a loan is approved by the ELO.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media (—e.g., air and/or space).

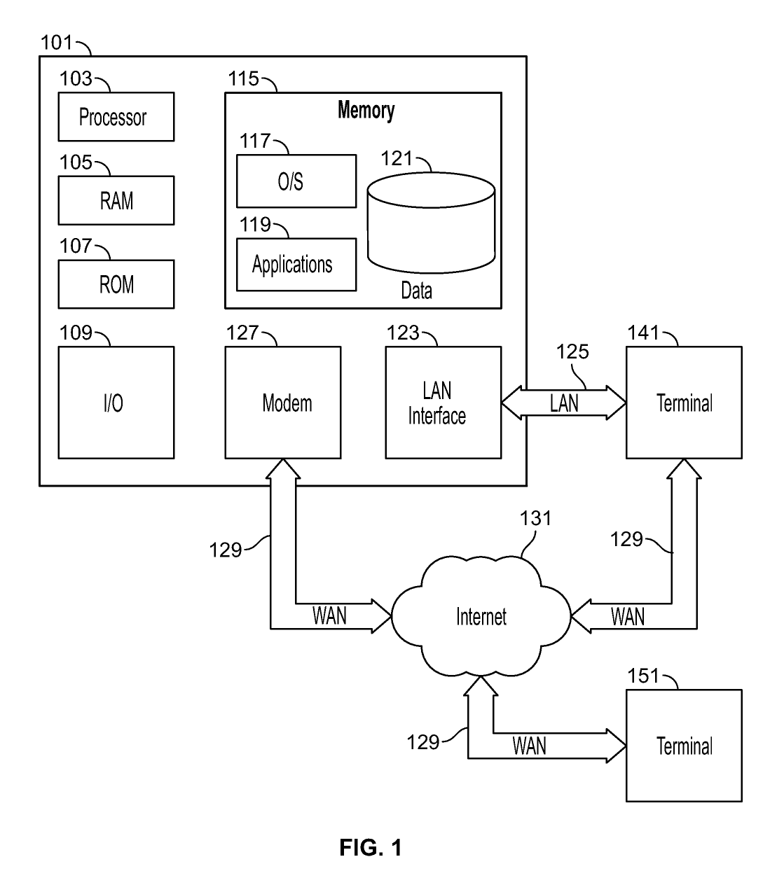

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to transmit and receive scoring models, credit reports, loan descriptions, and perform any other suitable tasks related to express loan origination and global underwriting.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer information, scoring models, credit reports, loan descriptions and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: global underwriting and loan origination and performing any other suitable tasks related to assessing value associated with underwriting.

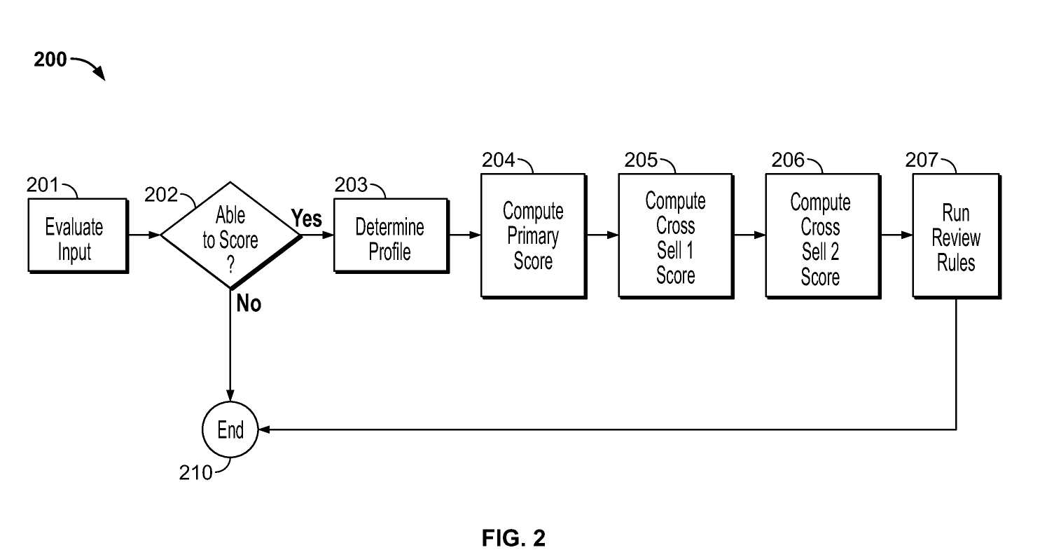

FIG. 2 is a flow chart showing an embodiment 200 of the steps which implement the ELO method including custom scoring. At step 201 the input from the potential borrower may be evaluated for adequacy. An adequate response may satisfy several criteria such as completeness, having a known address, a known entity name, etc. At step 202 a decision may be made to end the process at step 210 or continue the process at step 203.

At step 203 a profile may be established for the potential borrower. The profile may be used to select a suitable model for evaluating the creditworthiness of the potential borrower. One model may be used for all potential borrowers or a model may be selected from 2 or more choices. The model choice may be affected by the size of the loan, the type of collateral provided by the potential borrower, the type of credit reports or any other suitable criteria. Preferably three models are used by the ELO.

Scoring models may be organized around the type of loan that the borrower requests. Illustrative loan types are unsecured loans, secured loans and card based products—e.g. credit or debit cards. Any combination of loans may also be scored. Models may be based on rules or any other suitable method.

Next, at step 204 the selected rule set may be used to compute a primary credit score—i.e. a custom score. Each model may utilize a different mix of fields from credit bureau reports. In some embodiments, one or more of the models may use between 9 and 14 of 29 fields. Each field within a model may contain a range of values and an accompanying score and weighting for that field. Fields within models may be evaluated; their component scores and weighting may be derived.

The set of component scores may be summarized to create the custom score for that particular model. The fields for the model may then be sorted based on the weightings assigned to fields to determine a list of adverse action codes. The adverse action codes may be associated with a custom scoring response to the potential borrower. The number of adverse action codes is not limited by may be as few as one.

Although 9, 14 and 29 fields are described as part of a typical embodiment, any number of fields within a credit report or derived from a credit report may be used by any model.

Next, at step 205 a first cross-sell score may be computed. A cross-sell score may be used to offer various products—e.g., a checking account—to the potential borrower. Next, at step 206 a second cross-sell score may be computed. The first and second cross-sell computations may also be created using scoring, weighting and summarization processes as described with respect to the primary credit score.

The models used for computing the first and second cross-sell scores may be different from the model used to compute the primary credit score. In the alternative, the same model may be used to compute all scores. The choice of model for the first and second cross cell evaluation may depend on the primary credit score. In the alternative, other criteria—e.g., current business conditions—may dictate the choice of model used for cross-sell opportunities.

Next, the review rules are evaluated at step 207. Review rules interpret the reason for the failure to allow origination of the requested loan. Such reasons may include inadequate collateral, inadequate cash flow to support the loan or any other suitable reason. After step 207 the ELO process 200 ends at step 210. The set of models, the score from each model and the Adverse Action Codes may be stored in the GUS.

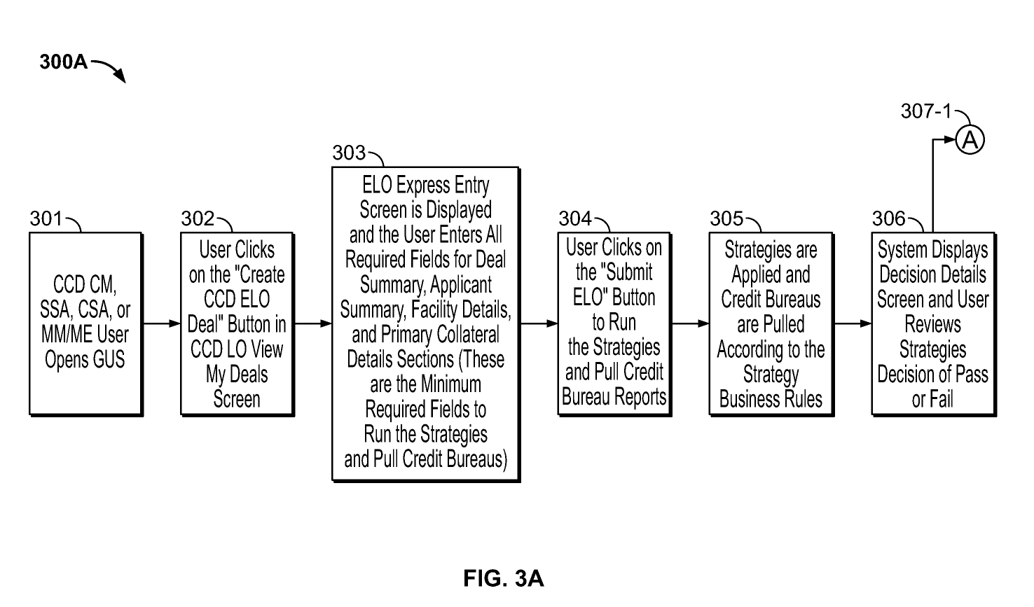

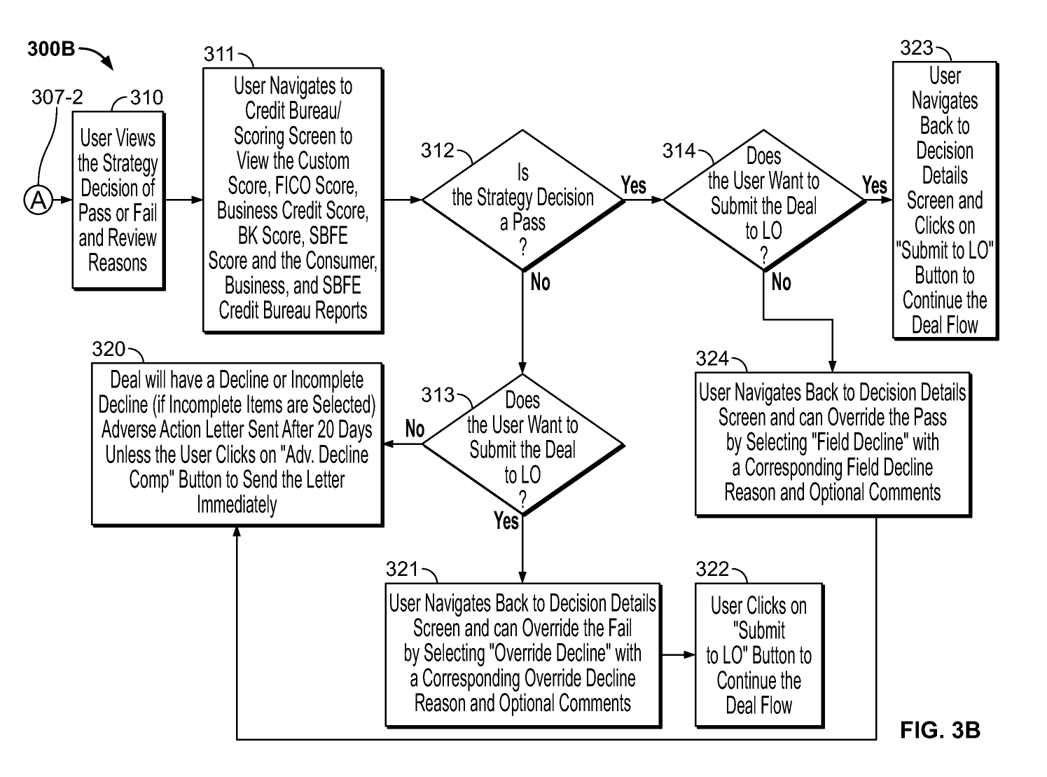

FIG. 3A shows a first portion 300A of a flow chart of an alternate embodiment which implements the ELO method including custom scoring.

At step 301 a Centralized Credit Delivery (CCD) Client Manager (CM), a Sales and Service Associate (SSA), a Client Support Associate (CSA) or Market Manager/Market Executive (MM/ME) may open the Global Underwriting System (GUS) software. A CCD may be a business unit that is synonymous with Business Banking. The GUS software may comprise an ELO application.

Next, at step 302 the user who opened the GUS software creates a CCD ELO deal utilizing the My Deals screen.

A screen may be a user interface that permits entry of user data. The My Deals screen is one of several possible screens utilized as an interface to a user of an ELO application within the GUS software.

Next, at step 303 ELO express entry screen is displayed. The user may then enter data into all required fields for the Deal Summary, Applicant Summary, Facility Details and Primary Collateral Details sections. The Deal Summary, Applicant Summary, Facility Details and Primary Collateral Details sections are the minimum fields to run the strategies implemented by the models and to acquire—i.e., pull—credit bureau reports.

Next, at step 304 the user may submit the data entered in step 303 to the strategies software and retrieve suitable credit bureau reports. The strategies software may make use of one or more credit evaluation models.

Next, at step 305 strategies—i.e. evaluation models—are applied to the data. The data gathered in step 303 may be supplemented by data acquired from one or more credit bureaus according to the strategy business rules.

Next, at step 306 the ELO application displays a Decision Details screen. The user may review the pass/fail decision. Step 306 is connected via connector 307-1 labeled “A” to step 310 of FIG. 3B. The connector 307-2 on FIG. 3B indicates a connection between flowchart 300A and flowchart 300B on FIG. 3B.

FIG. 3B shows a second portion 300B of a flow chart of an alternate embodiment which implements the ELO method including custom scoring. Connector 307-2 labeled “A” indicates a connection between FIG. 3A and FIG. 3B, between connector 307-1 and connector 307-2, and between steps 306 and 310.

Following step 306 on FIG. 3A, at step 310 the user may view the strategy decision of pass or fail and review the reasons for passing or failing.

Next, at step 311 a user may navigate to the Credit Bureau/Scoring screen to view the custom score. The custom score may be the output of the strategy/model. The user may also view the Fair Isaac Corporation (FICO) score, the Business Credit score, the Small Business Financial Exchange (SBFE) score and the consumer, business and SBFE credit reports as well as any other suitable report or score.

Next, at step 312 the strategy/model decision is checked. If the strategy decision is a fail then at step 313 the user is queried regarding the submission of the deal to Loan Origination (LO). Loan Origination is a module in the GUS system that may permit the origination—i.e., the creation—of a loan.

If the decision is to submit the deal to LO, then at step 321 the user navigates to the Decision Details screen. The Decision Details screen permits the user to override the conclusion of the strategy/model. The user may provide an Override Decline Reason and/or comments.

Next, at step 322 the user may submit the deal to the LO and continue the deal flow towards origination of a loan. Loan origination concludes the utilization of the ELO application.

If the user does not wish to submit the deal to the LO and override the conclusion of the strategy/model then at step 320 the deal will be declined. The deal may be declined or incomplete decline if the incomplete items are selected. Typically, an Adverse Action letter is sent after 20 days to the potential borrower, explaining the reasons for refusal and offering cross-sell proposals. In the alternative, the user may choose to send the letter immediately.

If the strategy decision is a pass, then at step 314 the user is queried regarding the submission of the deal to LO. If the decision is to submit the deal to LO, then at step 323 the user navigates to the Decision Details screen and may submit the deal to LO and continue the deal flow towards origination of a loan. Loan origination concludes the utilization of the ELO application.

If the user does not wish to submit the deal to LO and override the conclusion of the strategy/model then at step 324 the user may navigate to the Decision Details screen and override the pass decision by selecting “Field Decline.” The user may enter a Field Decline Reason and/or comment.

Declining an approved loan may occur if the loan terms described were unacceptable to the potential borrower. It is possible that several alternate loan arrangements may be computed by a user in an attempt to find a loan for a potential borrower that has acceptable terms.

Next, at step 320 the deal may be declined. The deal may be declined or incomplete decline if the incomplete items are selected. Typically, an Adverse Action letter is sent after 20 days to the potential borrower, explaining the reasons for refusal and offering cross-sell proposals. In the alternative, the user may choose to send the letter immediately.

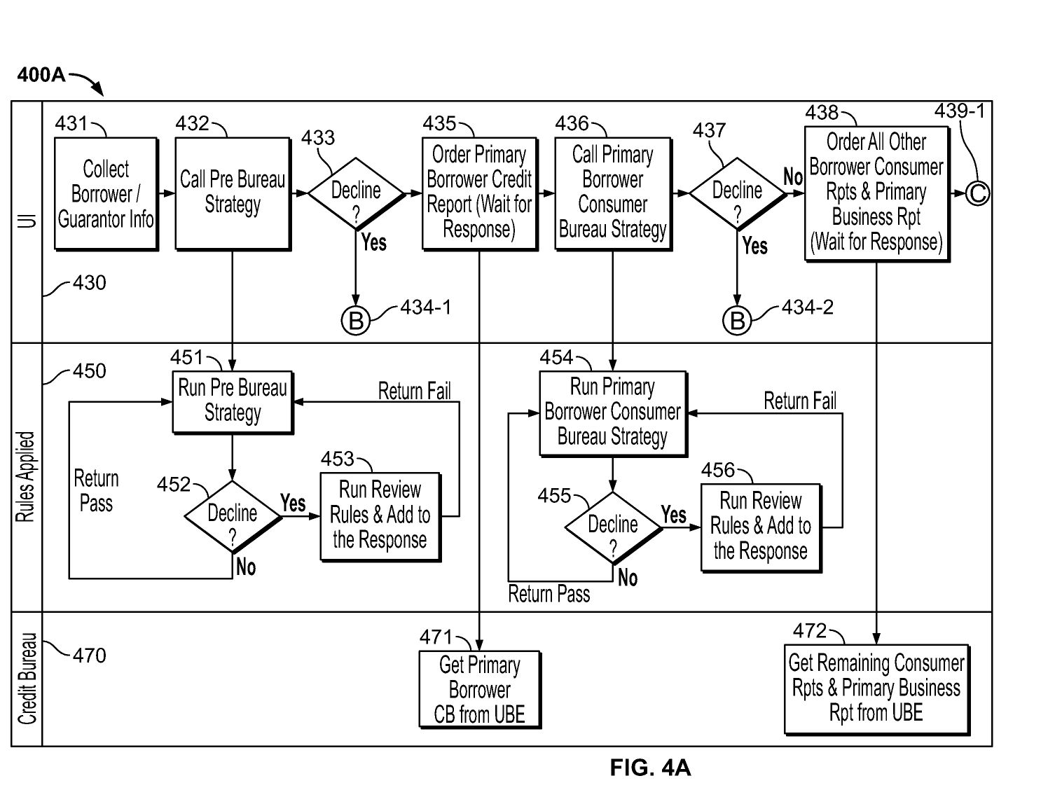

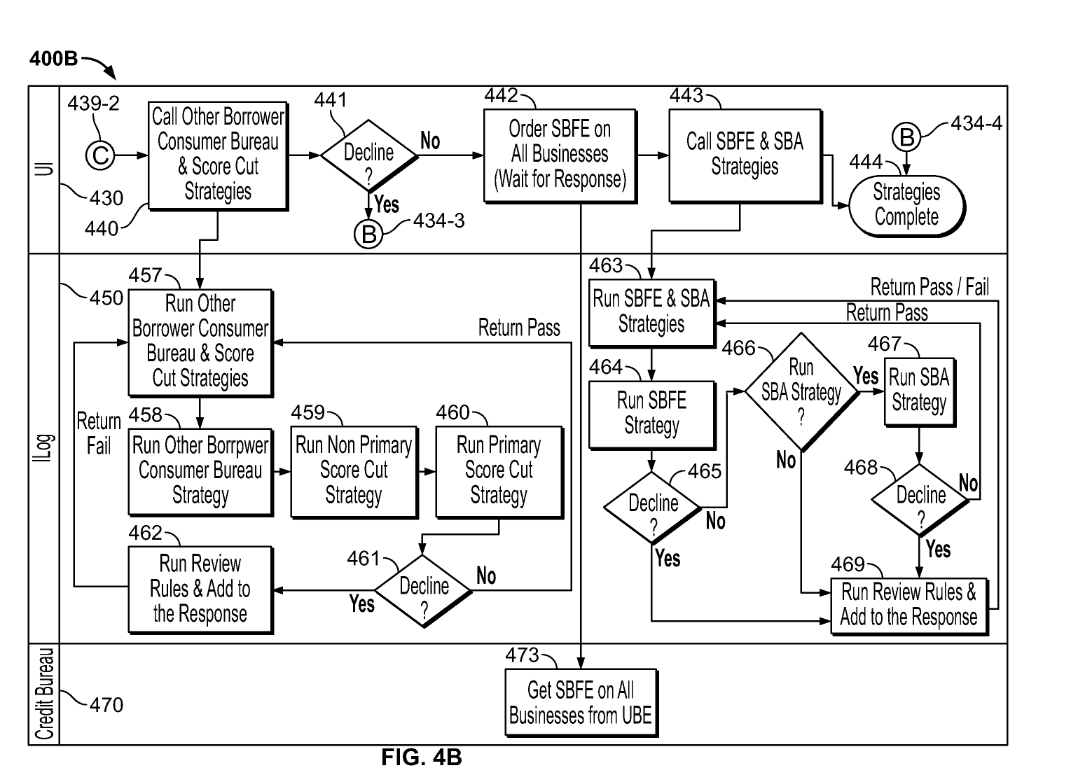

FIG. 4A shows a first portion 400A of a flow chart of an alternate embodiment which implements the ELO method including use of a logic engine. This embodiment may make use of a multi stage credit verification procedure. The stages may be divided into a pre-bureau credit check, a primary credit check, consumer and score cut check and a SBFE and Small Business Administration (SBA) check but other divisions and more than four or less than four divisions are contemplated and included within the scope of the invention.

The flow chart 400A utilizes three regions. Region 430 is the User Interface (UI) region that implements the user interface of the ELO application seen by the user. Region 450 is the logic engine region which applies the rules of the strategy/model. Region 470 is the credit bureau region that provides credit information of a potential borrower when queried by the ELO application.

Each region is part of the overall operation of the ELO. Each region may be executed on different hardware platforms or two or more regions may be executed on the same hardware platform.

At step 431 in region 430 potential borrower information may be collected. Information about a guarantor may be collected as well. Information may be collected automatically from online sources or it may be entered in a screen shown by the UI 430.

Next, at step 432 the pre-bureau strategy rules in the logic engine region 450 may be activated. At step 451 the pre-bureau rule or rules are run by a logic engine. The logic engine may be an ILOG logic engine or any suitable rule engine or software/hardware combination. The rule or rules may generate a pre-bureau score.

Next, at step 452 the results of the pre-bureau evaluation are examined. If the loan is declined then pre-bureau review rule or rules are run to produce a pre-bureau response at 453. The pre-bureau response is an explanation of the rejection at the pre-bureau stage for the potential borrower. After the review is complete, the logic engine returns a fail to step 432 via step 451.

If the pre-bureau rules allow the loan process to advance the logic engine returns a pass to step 432 via step 451.

After step 432 has accepted the result of the pre-bureau strategy, the result is tested at step 433. If the result is a fail then the program terminates via connector 434-1 labeled “B”. Connector 434-1 indicates a connection between FIG. 4A and FIG. 4B, between connector 434-1 and connector 434-4 and between steps 433 and 444. Step 444 is the completion step for the ELO flow chart 400A and 400B.

If the result is a pass then primary borrower credit report may be requested at step 435. At step 471 of the credit bureau 470, the Credit Bureau (CB) may acquire the primary report of the potential borrower from the Universal Bureau Engine (UBE). The UBE acquires credit reports from any needed agency. The reports may be returned to step 435. Step 435 may wait until the appropriate reports are received.

Next, at step 436 the primary strategy rules in the logic engine region 450 may be activated. At step 454 the primary rule or rules are run by the logic engine. The rule or rules may generate a primary score.

Next, at step 455 the results of the primary evaluation are examined. If the loan is declined then a primary strategy review rule or rules are run to produce a primary strategy response at 456. The primary strategy response is an explanation of the rejection at the primary strategy stage for the potential borrower. After the review is complete, the logic engine returns a fail to step 436 via step 454.

If the primary rules allow the loan process to advance the logic engine returns a pass to step 436 via step 454.

After step 436 has accepted the result of the primary strategy, the result is tested at step 437. If the result is a fail then the program terminates via connector 434-2 labeled “B”. Connector 434-2 indicates a connection between FIG. 4A and FIG. 4B, between connector 434-2 and connector 434-4 and between steps 437 and 444.

If the result is a pass then other borrower reports may be requested at step 438. At step 472 of the credit bureau 470 the CB may acquire the remaining consumer reports, primary business reports and any other suitable reports from the UBE. The UBE acquires credit reports from any needed agency. The reports may be returned to step 438. Step 438 may wait until the appropriate reports are received.

Step 438 is connected to the second portion of the flow chart 400B via connector 439-1 labeled “C”. Connector 439-1 indicates a connection between FIG. 4A and FIG. 4B, between connector 439-1 and connector 439-2 and between steps 438 and 440.

Next, at step 440 the other borrower/consumer and score cut strategy rules in the logic engine region 450 may be activated. At step 457 the other borrower/consumer and score cut strategy rules are run by the logic engine.

Next, at step 458 the other borrower and/or consumer bureau rule or rules are run by the logic engine. Preferably a multi-level evaluation is used whereby results from a first level may be used by a second level. Next, at step 459 the non-primary score cut rules are run. Next, at step 460 the primary score cut rules are run. In the alternative, two more levels of the evaluation may be combined. Only one level or more than two levels of evaluation are also contemplated and included within the scope of the invention. At each level the rule or rules may generate an intermediate cut score. The primary cut score is preferably a combination of intermediate cut scores.

Next, at step 461 the results of the other borrower, consumer and score cut evaluations are examined. If the loan is declined then other borrower, consumer and score cut review rules or rules are run to produce another response at 462. The other response is an explanation of the rejection at other borrower stage for the potential borrower. After the review is complete, the logic engine returns a fail to step 440 via step 457.

If the other borrower/consumer and score cut rules allow the loan process to advance the logic engine returns a pass to step 440 via step 457.

After step 440 has accepted the result of the other borrower/consumer and score cut strategy, the result is tested at step 441. If the result is a fail then the program terminates via connector 434-3 labeled “B”. Connector 434-3 to 434-4 connects between steps 441 and 444.

If the result is a pass then a SBFE and SBA report may be requested at step 442. At step 473 of the credit bureau 470 the CB may acquire the SBFE and SBA report of the potential borrower from the UBE. The UBE acquires credit reports from any needed agency. The reports may be returned to step 442. Step 442 may wait until the appropriate reports are received.

Next, at step 443 the SBFE and SBA strategy rules in the logic engine region 450 may be activated. At step 463 the SBFE and SBA strategy rule or rules are run by the logic engine. The rule or rules may generate a SBFE/SBA score.

Next, at step 464 the SBFE rule or rules are run by the logic engine. Next, at step 465 the results of the SBFE evaluation are examined. If the loan is declined then SBFE/SBA review rules or rules are run to produce a SBFE/SBA response at 469. The response is an explanation an explanation of the rejection at SBFE/SBA stage for the potential borrower. After the review is complete, the logic engine returns a fail to step 443 via step 463.

If the SBFE rules allow the loan process to advance the logic engine evaluates the feasibility of running the SBA rule or rules. If it is infeasible to run the SBA rule or rules, then SBFE and SBA review rules or rules are run to produce a response at 469 as described above. After the review is complete, the logic engine returns a fail to step 443 via step 463.

If it is feasible to run the SBA rules then the SBA rule or rules are run at step 467. Next, at step 468 the results of the SBA evaluation are examined. If the loan is declined then SBFE and SBA review rules or rules are run to produce a response at 469 as described above. After the review is complete, the logic engine returns a fail to step 443 via step 463.

If the SBA evaluation allows the loan process to advance the logic engine returns a pass to step 443 via step 463. In the alternative, two more levels of the evaluation process may be combined.

After step 443 has accepted the result of the other borrower/consumer and score cut strategy process is completed ate step 444. Completion may result in a positive outcome and result in the creation of a new loan. Or, the outcome could be negative and reasons will be conveyed to the potential borrower. In the alternative, cross-sell opportunities or other financial options may be presented to the potential borrower.

Thus, apparatus and methods that allow a user to rapidly originate a loan are provided.

Persons skilled in the art will appreciate that the present invention can be practiced by other than the described embodiments, which are presented for purposes of illustration rather than of limitation, and that the present invention is limited only by the claims that follow.

What is claimed is:

1. A method of originating a loan, the method comprising:
using a receiver to receive potential borrower financial information;
using a processor in communication with the receiver to determine at least one primary score;
using the processor to determine at least one cross-sell score;
using the processor to select review rules based on the outcome of the primary score; and
using the processor to evaluate the potential borrower information based on the review rules.

2. The method of claim 1 further comprising using a processor to reject the potential borrower information if the potential borrower information is not complete.

3. The method of claim 1 further comprising using a processor to terminate the method if the potential borrower information is not complete.

4. The method of claim 1 further comprising using a processor to terminate the method if the potential borrower information is inconsistent.

5. The method of claim 1 further comprising using the receiver to acquire credit information relevant to the potential borrower.

6. The method of claim 5 further comprising using a processor to apply a rule set to the credit information in order to determine the primary credit score.

7. The method of claim 6 further comprising using a processor to submit the loan to a loan origination process if the primary credit score surpasses a pre-determined threshold, said pre-determined threshold indicates creditworthiness.

8. The method of claim 6 further comprising using a processor to decline submission of the loan to a loan origination process if the primary credit score surpasses a threshold value, said threshold value indicates creditworthiness.

9. The method of claim 6 further comprising using a processor to submit the loan to a loan origination process if the primary credit score does not surpasses a pre-determined threshold, said pre-determined threshold indicates creditworthiness.

10. The method of claim 6 further comprising using a processor to notify the potential borrower of the reasons for rejection if the primary credit score does not surpasses a pre-determined threshold, said pre-determined threshold indicates creditworthiness.

11. A method of originating a loan, the method comprising:
using a receiver to receive potential borrower information;
using a processor in communication with the receiver to determine at least one score based on at least one credit report;
using the processor to decline origination of the loan if the score is insufficient; and
using the processor to initiate the loan origination process if the score is sufficient.

12. The method of claim 11 wherein the determination is performed by a rules engine.

13. The method of claim 11 further comprising using the receiver to acquire at least one credit report.

14. The method of claim 11 further comprising using a processor to determine a pre-bureau score based on potential borrower information.

15. The method of claim 14 further comprising using a processor to apply review rules if the pre-bureau score is insufficient.

16. The method of claim 11 further comprising using a processor to determine a primary score if an evaluation of the at least one credit report is acceptable.

17. The method of claim 11 further comprising using the receiver to acquire at least one second credit report if the at least one credit report is acceptable.

18. The method of claim 11 further comprising using a processor determine a primary cut score if an evaluation of the at least one credit report is acceptable.

19. The method of claim 19 wherein the primary cut score is determined in two levels.

20. The method of claim 11 wherein the score is insufficient when the score does not surpasses a pre-determined threshold.
